(19) United States
(12) Patent Application Publication
(10) Pub. No.: US 2009/0112918 A1
(43) Pub. Date: Apr. 30, 2009

(54) RICH MEDIA CONTENT WEB SITE ANALYTICS SYSTEM AND METHOD AND NETWORK ANALYTICS INFRASTRUCTURE EMPLOYING THE SAME

(75) Inventor: Stephen E. Terrell, Allen, TX (US)

Correspondence Address: HITT GAINES P.C., P.O. BOX 832570, RICHARDSON, TX, 75083, US

(73) Assignee: Team Banzai Media Group, Plano, TX (US)

(21) Appl. No.: 12/257,384

(22) Filed: Oct. 23, 2008

Related U.S. Application Data
(60) Provisional application No. 60/982,983, filed on Oct. 26, 2007.

(51) Int. Cl. G06F 17/30; G06F 15/16

(52) U.S. Cl. 707/102; 709/224; 707/E17.047; 707/E17.046; 707/E17.018

(57) ABSTRACT

A reporting server, a method of performing rich media content web site analytics and a network analytics infrastructure. In one embodiment, the reporting server includes: (1) a location mapper configured to receive messages directly from rich media message generators over a network and associate geographical locations with the messages based on logical addresses contained therein, (2) an analytics engine coupled to the location mapper and configured to create associations among the messages based on aggregation criteria received from a reporting client and (3) a graphical user interface generator coupled to the analytics engine and configured to generate at least one representation based on the associations and transmit the at least one representation to the reporting client.

### CROSS-REFERENCE TO PROVISIONAL APPLICATION

This application claims the benefit of U.S. Provisional Application Ser. No. 60/982,983, filed by Terrell on Oct. 26, 2007, entitled “Rich Media Content Website Analytics System and Method,” commonly assigned with the invention and incorporated herein by reference.

### COPYRIGHT AUTHORIZATION

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD OF THE INVENTION

The invention is directed, in general, to network analysis systems and, more specifically, to a rich media content web site analytics system and method and a network analytics infrastructure employing the system or the method.

### BACKGROUND OF THE INVENTION

The Defense Advanced Research Projects Agency originally envisioned the Internet as being the way to link college campuses and government research facilities together to facilitate the interchange of fundamental research and defense technology. While the Internet still fulfills that original vision, its vistas extend far beyond. Today the Internet facilitates communication of every type of information whatsoever between individuals of every nation and groups of every size and kind, including commercial enterprises, charitable organizations and international, federal, state and local governmental agencies from all over the world.

The Internet holds almost boundless commercial opportunities. Consequently, and businesses have spent substantial time and money assembling sophisticated and attractive sites on the World Wide Web (“web sites”) to take advantage of those opportunities. However, as businesses took awhile to discover, it is not enough to offer clever web sites. It is also essential to assess the effectiveness of those web sites to understand how persons who use web sites (“users”) are navigating them and how they can be improved. Just as retailers have for many years surveyed their customers to understand where they live and work, their satisfaction with current offerings and their reactions to new offerings, and just as retailers study the when customers shop and the paths they take when walking through their stores, businesses of all types are keenly interested in understanding who their customers are, when and how they are navigating the web sites they have constructed and what their customers think could be done better.

As a result, a field of study called “web analytics” has arisen. Wikipedia.org defines web analytics as the study of online behavior in order to improve it and divides the field into two categories: offline web analytics and online web analytics. Offline web analytics is used to determine if a web site should even be established. Online web analytics is carried out with respect to an existing web site. Therefore, perhaps a more germane definition is that offered up by Outsource2india.com, which defines web analytics as the process of collection, measurement and analysis of user activity on a website to understand and help achieve the intended objective of the website.

Two mechanisms currently exist by which data is gathered as a basis for performing online web analytics. The former employs server logs, in which entries are generated as web servers fulfill requests by web clients (also known as browsers, including: Internet Explorer®, FireFox®, Opera®, Safari®, Mozilla®, Flock®, K-Meleon®, Camino®, OmniWeb®, iCab®, Konqueror®, Galeon® and Epiphany®) for web pages. Unfortunately, server logs do not truly reflect page views, because the web server does not directly fulfill all requests for web pages. The latter mechanism, which is somewhat more accurate, is called page tagging. Page tagging employs so-called “web bugs” to transmit information from the web client each time the web client renders a web page. Both techniques, though different, are directed to determining when a user is viewing a given web page.

Irrespective of which mechanism is used to gather data, conventional web analytics tools then sort the data into groups according to their Internet Protocol (IP) address and present the groups in tabular form. A person wishing to understand how a web site is used (an “analyst”) then reads and interprets the tables and makes business-critical decisions based thereon. The emphasis so far has been on increasing the accuracy by which page views are determined and the number of different ways the page view data can be analyzed.

### SUMMARY OF THE INVENTION

To address the above-discussed deficiencies of the prior art, the invention provides a reporting server. In one embodiment, the reporting server includes: (1) a location mapper configured to receive messages directly from rich media message generators over a network and associate geographical locations with the messages based on logical addresses contained therein, (2) an analytics engine coupled to the location mapper and configured to create associations among the messages based on aggregation criteria received from a reporting client and (3) a graphical user interface (GUI) generator coupled to the analytics engine and configured to generate at least one representation based on the associations and transmit the at least one representation to the reporting client.

Another aspect of the invention provides a method of performing rich media content web site analytics. In one embodiment, the method includes: (1) receiving messages directly from rich media message generators over a network, (2) associating geographical locations with the messages based on logical addresses contained therein, (3) creating associations among the messages based on aggregation criteria received from a reporting client, (4) generating at least one representation based on the associations and (5) transmitting the at least one representation to the reporting client.

Yet another aspect of the invention provides a network analytics infrastructure. In one embodiment, the infrastructure includes: (1) web content locatable at web servers, transmittable to web clients over the Internet and including rich media content and associated rich media message generators and (2) a reporting server. The reporting server includes: (2a) a location mapper configured to receive, over the Internet, messages from the rich media message generators transmitted to the web clients and associate geographical locations with the messages based on IP addresses contained therein, (2b) an analytics engine coupled to the location mapper and configured to create associations among the messages based on aggregation criteria received from a reporting client and (2c) a GUI generator coupled to the analytics engine and configured to generate at least one representation based on the associations and transmit the at least one representation to the reporting client.

Still another aspect of the invention provides a rich media message generator embodied in a sequence of executable computer instructions expressed in a computer language selected from the group consisting of: Flash®, QuickTime® and Silverlight® and configured to be associated with rich media, transmitted to a web client over the Internet, generate rich media messages and cause the rich media messages to be transmitted to a reporting server over the Internet.

### BRIEF DESCRIPTION OF THE DRAWINGS

For a more complete understanding of the invention, reference is now made to the following descriptions taken in conjunction with the accompanying drawings, in which:

FIG. 1 is a high-level diagram illustrating one embodiment of a network analytics infrastructure involving a flow of information among a plurality of network elements carried out according to the principles of the invention;

FIG. 2 is a more detailed block diagram of one embodiment of a reporting server constructed according to the principles of the invention along with the network elements of FIG. 1;

FIG. 3 is a screen capture of one embodiment of a graphical data representation as provided by one embodiment of a reporting server constructed according to the principles of the invention;

FIG. 4 is a screen capture of one embodiment of a legend panel as provided by one embodiment of a reporting server constructed according to the principles of the invention;

FIG. 5 is a screen capture of one embodiment of engagement and map information panels as provided by one embodiment of a reporting server constructed according to the principles of the invention;

FIG. 6 is a more detailed screen capture of one of the engagement panels of FIG. 5;

FIG. 7 is a more detailed screen capture of the map information panel of FIG. 5;

FIG. 8 is a screen capture of one embodiment of a campaign panel as provided by one embodiment of a reporting server constructed according to the principles of the invention;

FIG. 9 is a screen capture of one embodiment of a chronology panel as provided by one embodiment of a reporting server constructed according to the principles of the invention;

FIG. 10 is a screen capture of one embodiment of a top paths panel as provided by one embodiment of a reporting server constructed according to the principles of the invention;

FIG. 11 is a screen capture of one embodiment of a content views panel as provided by one embodiment of a reporting server constructed according to the principles of the invention;

FIG. 12 is a screen capture of one embodiment of a project panel as provided by one embodiment of a reporting server constructed according to the principles of the invention;

FIG. 13 is a screen capture of one embodiment of a questionnaire panel as provided by one embodiment of a reporting server constructed according to the principles of the invention;

FIG. 14 is a screen capture of one embodiment of a favorites panel as provided by one embodiment of a reporting server constructed according to the principles of the invention;

FIG. 15 is a screen capture of one embodiment of an organizations panel as provided by one embodiment of a reporting server constructed according to the principles of the invention;

FIG. 16 is a flow diagram of one embodiment of a method of creating a message generator, associating the message generator with rich media content and employing the message generator to generate messages carried out according to the principles of the invention; and

FIG. 17 is a flow diagram of one embodiment of a method of performing rich media content web site analytics carried out according to the principles of the invention.

### DETAILED DESCRIPTION

As stated above, the emphasis so far has been on increasing the accuracy by which page views are determined and the number of different ways the page view data can be analyzed. However, irrespective of the mechanism employed to gather data, and irrespective of the sophistication of the analysis of the data, conventional web analytics tools still operate on page views. Other conventional web analytics tools use Java® or ActiveX® scripts to transmit data from a web client for analysis. However, many web clients allow users to disable Java® and ActiveX® scripts for sound security reasons, and many users do. As a result, those web clients in which such scripts have been disabled do not transmit data, and the resulting analyses performed by such other conventional web analytics tools are inaccurate by virtue of being incomplete.

Over the last several years, sophisticated web sites have begun to incorporate large amounts of “rich media” content. Rich media may be defined as interactive multimedia driven by scripts and providable to a web client as part of a web page expressed in a markup language, such as the well-known HyperText Markup Language (HTML). A suitable definition is also found in Schafer “What is Rich Media, Really?” ClickZ, page no. 3616251, Jun. 30, 2006, which is incorporated herein by reference.

Rich media scripts are designed to execute on rich media platforms or players. Modern rich media platforms or players include Flash® (commercially available from Adobe Systems Incorporated of Mountain View, Calif.), QuickTime® (commercially available from Apple Inc. of Cupertino, Calif.) and Silverlight® (commercially available from Microsoft Corporation of Redmond, Wash.).

Unfortunately, conventional web analytics tools do not operate with respect to rich media content. This is in part because no mechanism currently exists by which data regarding rich media usage can be generated and gathered. Further, even if such mechanism were to exist, conventional web analytics tools lack facilities for presenting the data such that an analyst can intuitively determine who is navigating a web site and how.

Described herein are various embodiments of systems, methods and infrastructures that allow comprehensive web analytics to be performed with respect to web sites that include rich media content. Some embodiments enhance the web analytics with page view data derived from server logs or web bugs. Other embodiments provide an analyst-configurable set of panels that may be concurrently displayed as part of a GUI image presented to the analyst. Still other embodiments are operable over a network, such as the Internet, allowing geographically-dispersed analysts to conduct web analytics with respect to geographically-dispersed web sites. Still further embodiments involve rich media content that does not originate at a web site (e.g., via electronic mail, through a peer network or on physical media). The latter embodiments allow sophisticated web analytics to be performed with respect to media distributed in a “viral” campaign or on CD-ROM.

Monitoring rich media usage with an external script, such as Javascript®, is heavily dependent upon user configurations. For example, JavaScript® page tagging requires Javascript and Javascript® cookies to be enabled on a given web client, Javascript cookies to be enabled. This is often not the case. Third-party cookies, which are required for banner ad tracking, are almost never enabled, so analyzing banner ads is impractical. Finally, standard Javascript® page tags either do not work to track rich media events, or give less-than-desirable reporting for rich media. So, some custom Javascript® functions must be written to work with custom Actionscript® event listeners.

In contrast, various of the embodiments avoid page tagging, whether in HTML or a script external to the rich media content. The player that plays the rich media content must be enabled, but that is going to be the case for any web client that is to view the rich media contant. Actionscript “Flash cookies” are more persistent than javascript cookies. Multiple Flash movies can share the same cookie, a session may be begun on one site and continued on another, which improves tracking. Sessions beginning with a click in a banner ad and continuing on to which the banner ad is linked, or for large Alternate-Reality-Games (ARGs), is supported. And, as stated above, in the case of “viral” rich media (media that is taken and distributed around the internet by consumers, rather than the original publishers), analysts can determine if and when their content has been re-posted on multiple websites, and which is the most popular. This could be used to help report on the success of a viral campaign, or alert the publisher to possible copyright infringement.

In the case of a rich media banner ad, analysts may use the latter feature to make sure that their banner ads are appearing on the sites on which they are paying to appear, and they may also be alerted to their banner being shown on sites on which they did not intend to advertise, or on inappropriate sites. Tracking can occur from site to site and from rich media banners, emails or local files to sites, and back again.

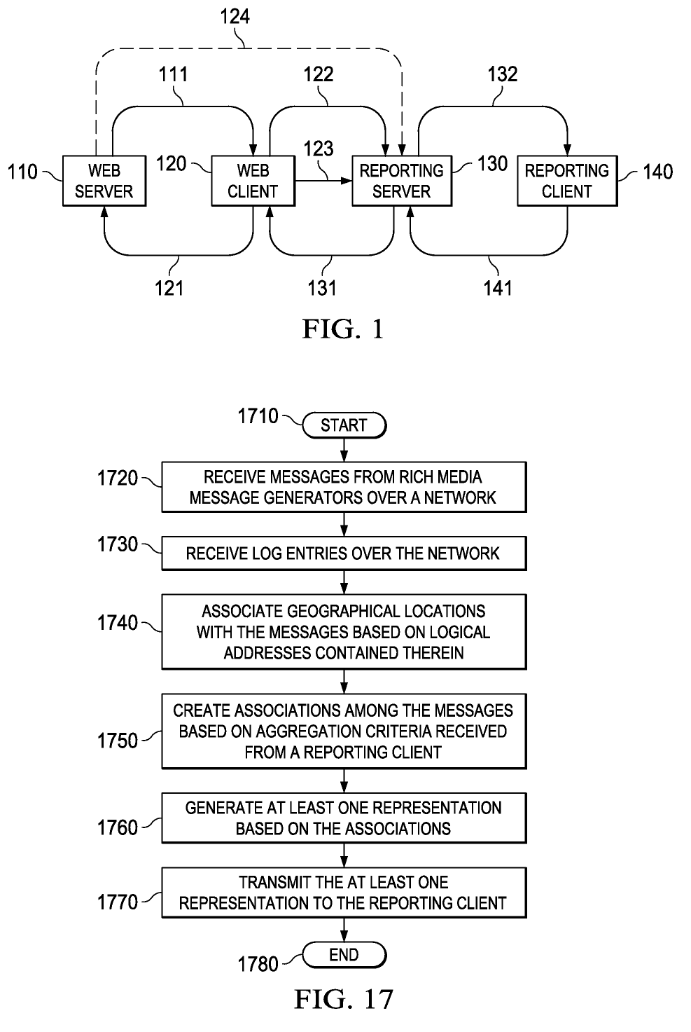

FIG. 1 is a high-level diagram illustrating one embodiment of a network analytics infrastructure involving a flow of information among a plurality of network elements carried out according to the principles of the invention. The network elements in the embodiment of FIG. 1 are a web server 110, a web client 120, a reporting server 130 and a reporting client 140. As a line 121 indicates, information first flows from the web client 120 to the web server 110 as the web client requests a web page that includes rich media from the web server 110. As a line 111 indicates, the web server 110 responds with the web pages. The web client 120 then renders the web page, causing the rich media content, which includes a message generator, to execute. As a line 122 indicates, the message generator generates and transmits a message to the reporting server 130 establishing a session. Because the message generator is native to the rich media content, it transmits the message to the reporting server 130 directly (not via an external script, such as Java® or ActiveX®, that may be disabled independent of the rich media content). As a line 123 indicates, the message generator then may generate and transmit one or more subsequent messages conveying activity that occurs during the session. As a line 131 indicates, the reporting server 130 acknowledges receipt of the messages. In certain embodiments, one or more log files may also be transmitted from the web server 110 to the reporting server as a line 124 indicates.

To perform rich media web analytics, an analyst at the reporting client 140 provides criteria of various sorts to the reporting server 130 as a line 141 indicates. In response, the reporting server 130 generates tabular and/or graphical representations of data conveying the web analytics and transmits the representations to the reporting client 140 as the line 132 indicates. Portions of the above-described flow of information are repeated for each session a user initiates or continues with a web site and each time an analyst undertakes rich media web analytics.

In an alternative embodiment, the web client 120 receives rich media content from other than the web server 110, e.g., via electronic mail, through a peer network or on physical media. Messages are generated and analytics are performed as described above.

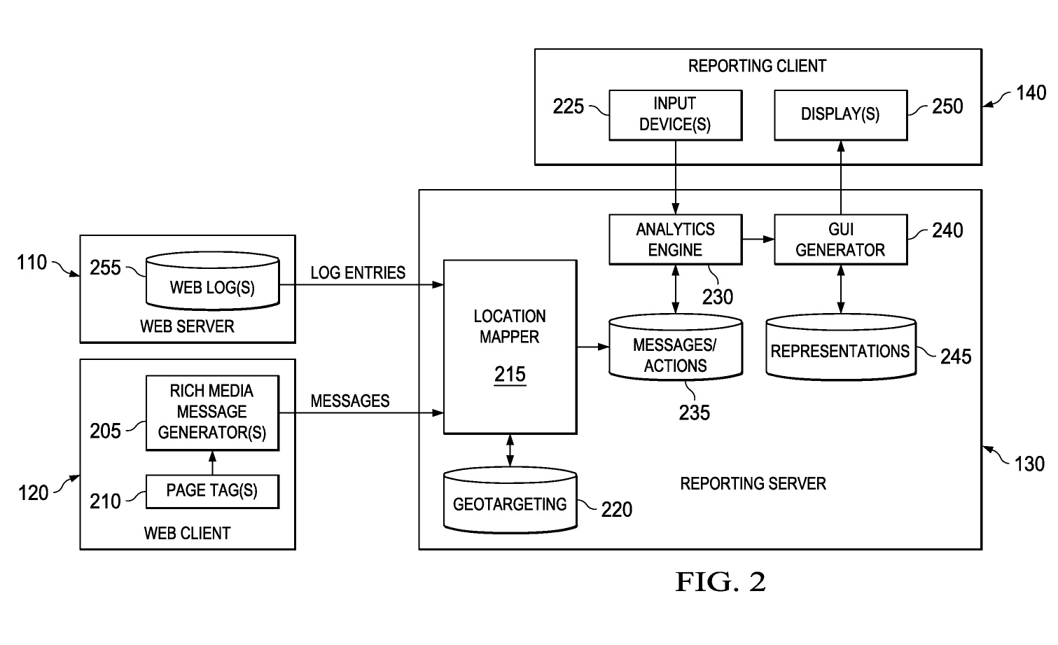

FIG. 2 is a more detailed block diagram of one embodiment of a reporting server constructed according to the principles of the invention along with the network elements of FIG. 1. Portions of the web server 110, web client 120, reporting server 130 and the reporting client 140 are shown in greater detail. The web client renders a web page that instantiates one or more rich media message generators 205. In a manner that will be described below in greater detail, the one or more rich media message generators 205 generate messages that are then transmitted to the reporting server 130. The one or more rich media message generators 205 transmit the messages to the reporting server 130 directly (not via an external script, such as Java® or ActiveX®, that may be disabled independent of the rich media content). The message provide indications of rich media usage by the user associated with the web client 120. One or more page tags 210 may also prompt the one or more rich media message generators 205 to generate messages indicating the rendering of a web page.

As stated above, an alternative embodiment provides that the web client 120 receive rich media content from other than the web server 110, e.g., via electronic mail, through a peer network or on physical media. Messages are generated and analytics are performed as described above and to be described below.

The web client 120 transmits the messages over a network (e.g., a personal area network, or PAN; a local area network, or LAN; a wide-area network, or WAN; an intranet; an extranet or the Internet) to a location mapper 215 in the reporting server 130. The location mapper 215 is configured to receive the messages and associate geographical locations with the messages based on logical addresses (e.g., IP addresses) contained therein. In the embodiment of FIG. 2, the location mapper 215 employs a geotargeting database 220 for this purpose.

In one embodiment, the geotargeting database 220 associates countries, regions, cities and Internet service providers (ISPs) to ranges of IP addresses on the Internet. In one embodiment, the geotargeting database 220 contains over 4 billion IP addresses. In one embodiment, the countries, regions, and cities in the geotargeting database 220 are associated with demographics tables to get demographic information about a specific country, county, state, city, continent, etc. The demographic information may come from data downloaded from the United States Census bureau, and includes information like population, number of households, median income, age statistics, etc.

The location mapper 215 is further configured then to store at least a part of the message, including its associated geographical location, in a messages/actions database 235. The messages/actions database 235 may contain the messages themselves or information related to the messages (e.g., user actions that prompted the generation of the messages).

In one embodiment, the messages/actions database 235 includes a table of company names and a table of users that stores usernames, passwords, and maps them to companies. In one embodiment, the messages/actions database 235 also contains a table that stores preference values for the GUI and maps them to user identifiers.

In one embodiment, the messages/actions database 235 also contains a project table that maps projects to company names, for permission purposes, and a table that maps the individual movie clips/Flash® clips/web pages to the projects. In one embodiment, the messages/actions database 235 also contains an activity table that include such information as necessary to generate reports for the different project sub-elements. In one embodiment, the messages/actions database 235 also contains a table that contains sessions, and their geotargeted information, and a table that contains all of the actions taken within the project, and maps them to session identifiers.

An analytics engine 230 is coupled to the location mapper 215 (indirectly via the messages/actions database 235 in FIG. 2). The analytics engine 230 is configured to create associations among the messages based on aggregation criteria received from a reporting client via one or more input devices 225 associated with the reporting client 140. The one or more input devices 225 may be, for example, a keyboard, a mouse or both. Some of the many ways in which the analytics engine 230 can create associations will be described below.

Criteria from the one or more input devices 225 may be reformulated as queries and saved as stored procedures in the messages/actions database 235. The analytics engine 230 then passes the parameters the queries require, including “roll-up” queries where the returned data is for an entire map, and others that return results for individual areas within the map. In the illustrated embodiment, the analytics engine is embodied in server-side scripts. There are also server-side scripts for writing messages to the messages/actions database 235 received from the rich media message generators 210 and pertaining to web content (web pages, video files, Flash® files, etc.). In one embodiment, the server-side scripts are written in asp.net.

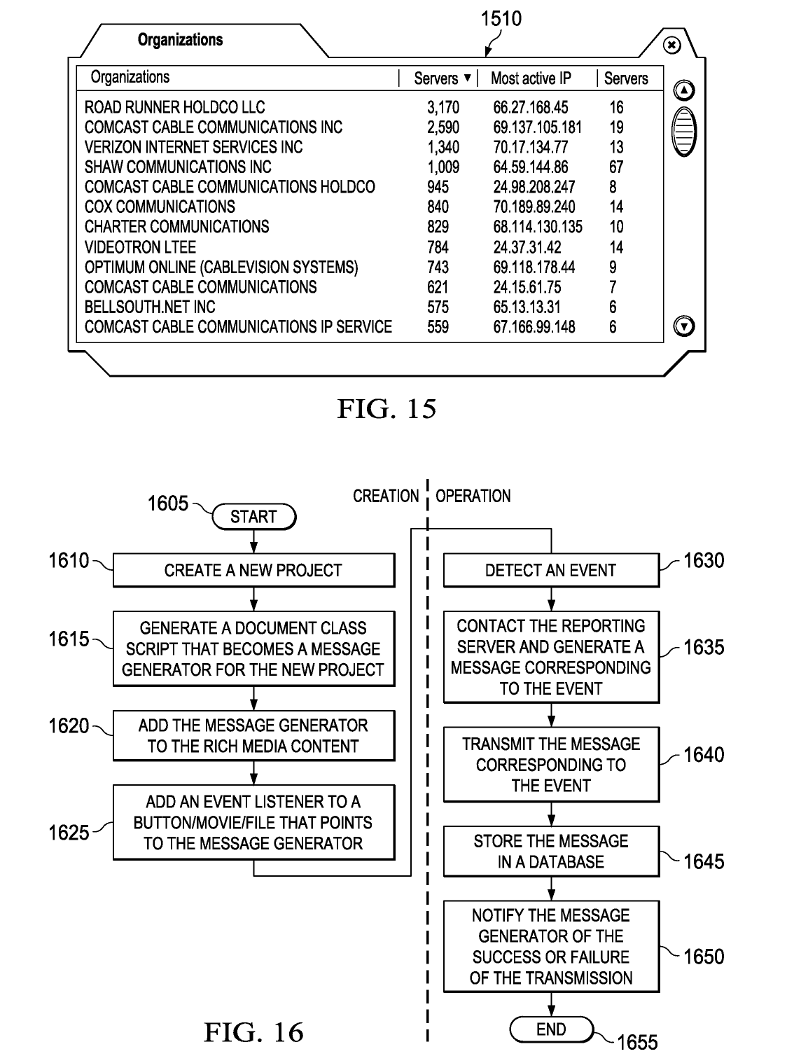

As described in conjunction with FIG. 15, below, server-side scripts may also return information from the reporting server 130 to the web client 120 when necessary. The web server 110 may then supply web content to the web client 120 based on the location of a resolved IP address, time of day, date, or other criteria.

A GUI generator 240 is coupled to the analytics engine 230. The GUI generator 240 is configured to generate at least one representation based on the associations and transmit the at least one representation to the reporting client 140. One or more displays 250 may then display the at least one representation for the benefit of the analyst.

The web server 110 includes one or more HTML server logs 255 that may likewise be transmitted in whole or in part to the location mapper 215 for eventual inclusion in the messages/actions database 235.

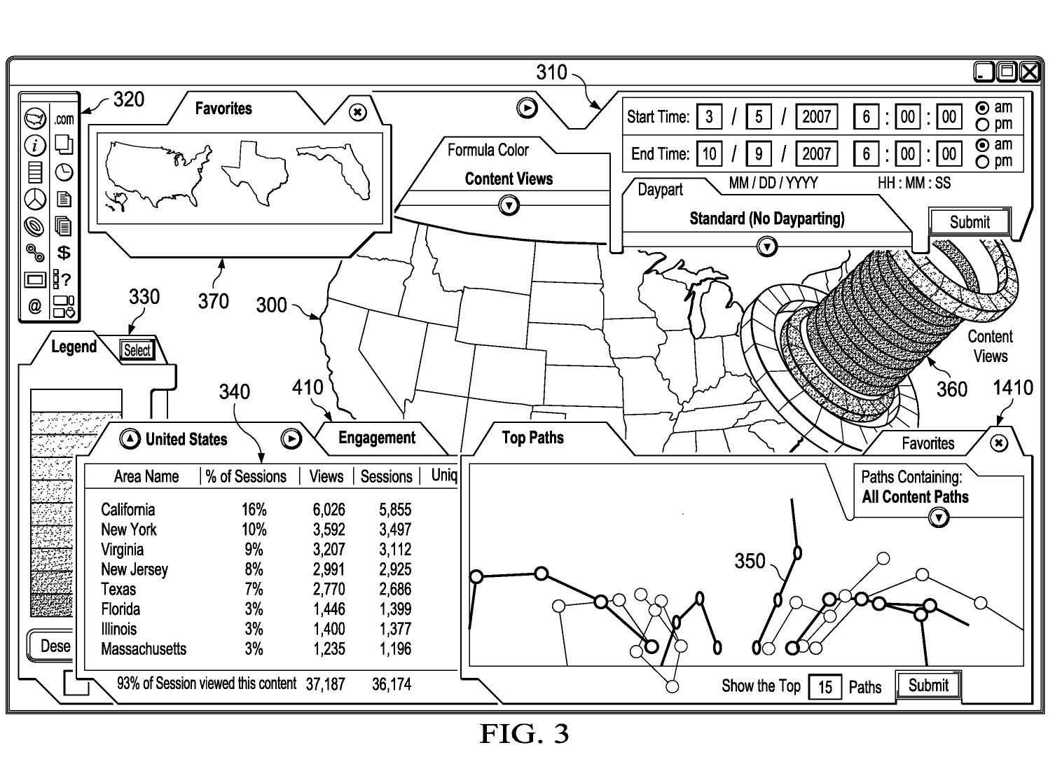

FIG. 3 is a screen capture of one embodiment of a graphical data representation as provided by one embodiment of a reporting server constructed according to the principles of the invention. In the illustrated embodiment, the GUI front end for the reporting server 130 is a Flash® front end populated with information from the databases 220, 235, 245 via the server-side scripts. The user is presented with a map 300 with surrounding panels (e.g., panels 310, 320, 330, 340, 350, 360) of supporting information. The panel information is relative to the map 300 that is presented, and clicking on an area of the map 300 drills down to the next level of detail (for example, World>North America>United States>Texas>Dallas-Fort Worth Metropolitan Statistical Area, or MSA).

A project panel 310 allows an analyst to set parameters for the map 300 by choosing the desired project and rich media content to be studied by using various demographic filters. Projects can be driven by date and time settings of individual preference or by accessing traditional predefined “dayparts” used by broadcasters.

A tools panel 320 gives an analyst various buttons corresponding to tools by which to manipulate the map 300 and the panels (e.g., panels 310, 320, 330, 340, 350, 360). Two of these buttons allow the map 300 to be split or collapsed. Another button allows printing to be done.

A legend panel 330 breaks down the numbers and colors for the map 300 into subsets. By shift clicking, an analyst can review the total percentage of subsets chosen.

A map information panels 340 gives an analyst a spreadsheet view of the data that is used to color the map 300. A top paths panel 350 shows clickstream data. A content views panel 360 shows content views for all of the rich media content “clips” in a given web site.

In the illustrated embodiment, when an analyst navigates to a new map 300, or changes the parameters for a current map 300 by changing the start or end dates or dayparts, a new query is run, a new copy of the map 300 is loaded and the old map 300 is shrunk and moved up to the top area of the screen. Accordingly, FIG. 3 shows old maps 370 that the map 300 has superseded but are still available to the analyst. If an analyst backs up to a previous query, the GUI generator 240 uses the previously generated map and information from the messages/actions database 235. Users can also click on the old maps 370 and jump back to them directly. This improves the speed of the analytics engine 230 and the GUI generator 240, as well as keeping unnecessary load off of the database server.

In the illustrated embodiment, the analyst can split the map 300, in which case the map 300 is divided into two copies of itself, which the analyst can navigated through independently of one another. In one embodiment, the map 300 can be split into up to six maps at one time. Whenever an analyst rolls over one of the areas on a map, all of the panels are updated to display the correct information for that map, and puts a border around it, so the user can tell which map the panels are displaying. Maps that have been split can also be removed from the GUI image.

Although FIG. 3 does not show it, a preference panel may be displayed. The preference panel allows an analyst to set custom preferences for all of the colors that are used in the GUI image. One embodiment of the preference panel also contains predefined color sets, including a default set, so the analyst can revert to the original color scheme. The analyst can also mute sounds by checking a mute sounds box.

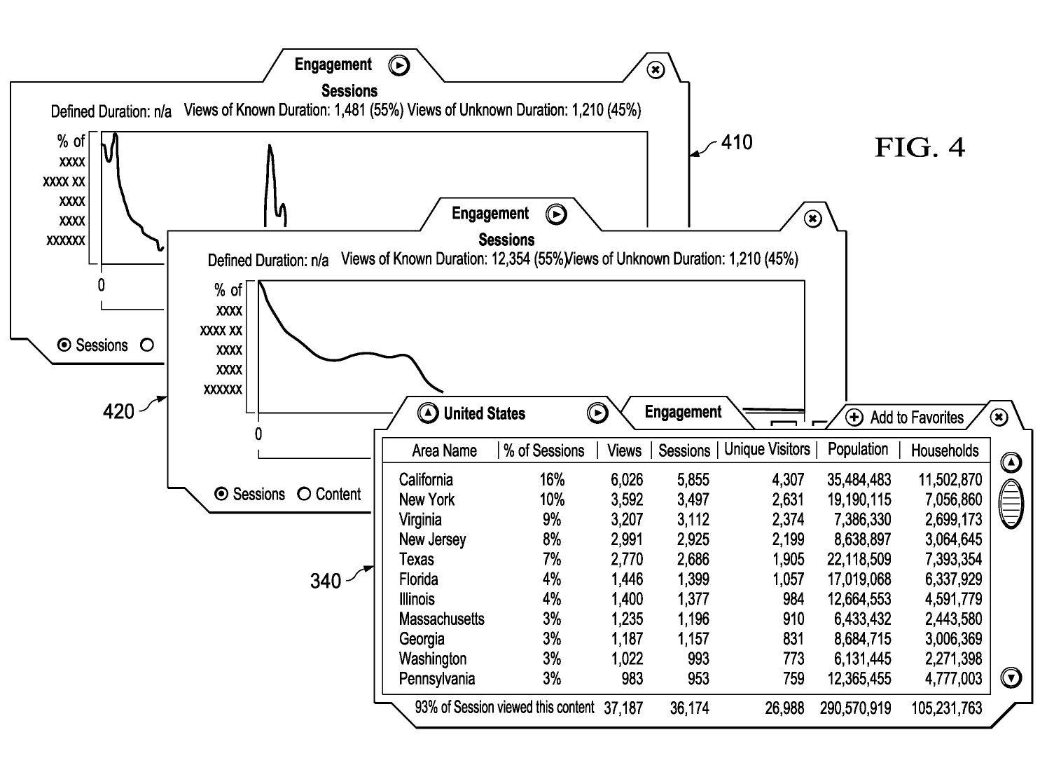

Continuing reference will be made to FIG. 3 in describing FIGS. 4-15. FIG. 4 is a screen capture of one embodiment of the legend panel 330. Again, the legend panel 330 breaks down numbers and colors for the map 300 into subsets. By shift clicking, an analyst can review the total percentage of subsets chosen.

The legend panel 330 shows all of the color values that are being used to color the map at any given time and contains buttons for adding or subtracting chips. The legend panel 330 also contains a text field that shows how many chips there currently are. An analyst can type a new number in if the analyst wants to add or remove chips that way. Since the number of color chips assigned to the legend panel 330 is so dynamic, the colors used for the different chips are procedurally generated. An analyst specify a darkest color and a lightest color in the preferences panel, and the legend generates the necessary steps between the two.

The legend panel 330 also has a slide out tray on the right side that gives the numerical values associated with each of the color boxes.

Additionally, rolling over a chip in the legend panel 330 highlights the chip, highlights all areas on the map that fall into that chip's numerical range, and gives the analyst a percentage of the total views/population/etc., that is highlighted. If the analyst holds the shift key down and clicks on the tiles, the areas the analyst has clicked on remain highlighted even after the analyst rolls onto another chip, and adds the percentages together. Clicking a reset button removes the highlights from all the shift-clicked chips.

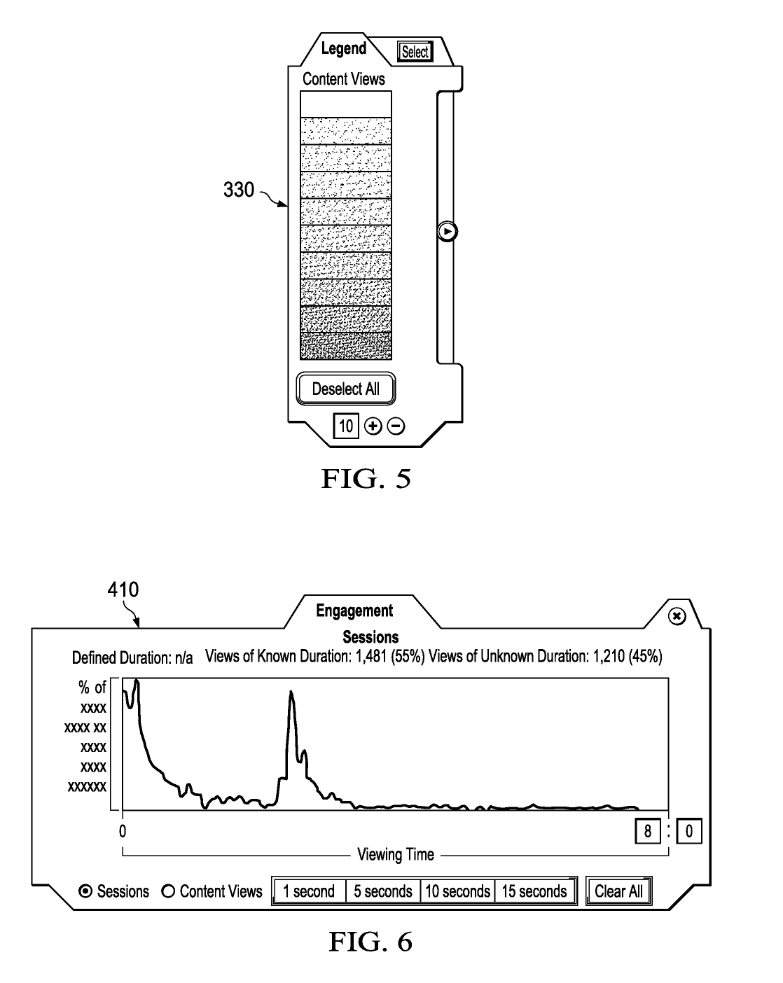

FIG. 5 is a screen capture of one embodiment of engagement panels 410, 420 and the map information panels 340. The engagement panels 410, 420 show the amount of elapsed time between one click to view a piece of rich media content (e.g., a video) and another click to end it. The engagement panels 410, 420 allow an analyst to determine how long users spend viewing different pieces of rich media content. An analyst can drag markers to different times, and the engagement panels 410, 420 show how many users have abandoned their viewing between the new marker and the previous one. There are also buttons to generate markers at specific intervals, and a button to clear all markers.

The map information panel 340 details as text the information displayed visually on the map 300. The map 300 is colored based on the formula selected in the project panel 310, and more information about the areas on the maps can be obtained by rolling over the different areas of the map 300, but the map information panel 340 provides more of a “spreadsheet” view of the data. It is also possible to click a button on the map information panel 340 that causes the reporting server 130 to generate a Microsoft® Excel® file of the results for the current map 300, which may be saved as desired.

FIG. 6 is a more detailed screen capture of the engagement panel 410. Again, the engagement panel 410 shows the amount of elapsed between one click to view a piece of rich media content and another click to end it. The engagement panel 410 allows an analyst to determine how long users spend viewing different pieces of rich media content. An analyst can drag markers to different times, and the engagement panel 410 shows how many users have abandoned their viewing between the new marker and the previous one. There are also buttons to generate markers at specific intervals, and a button to clear all markers.

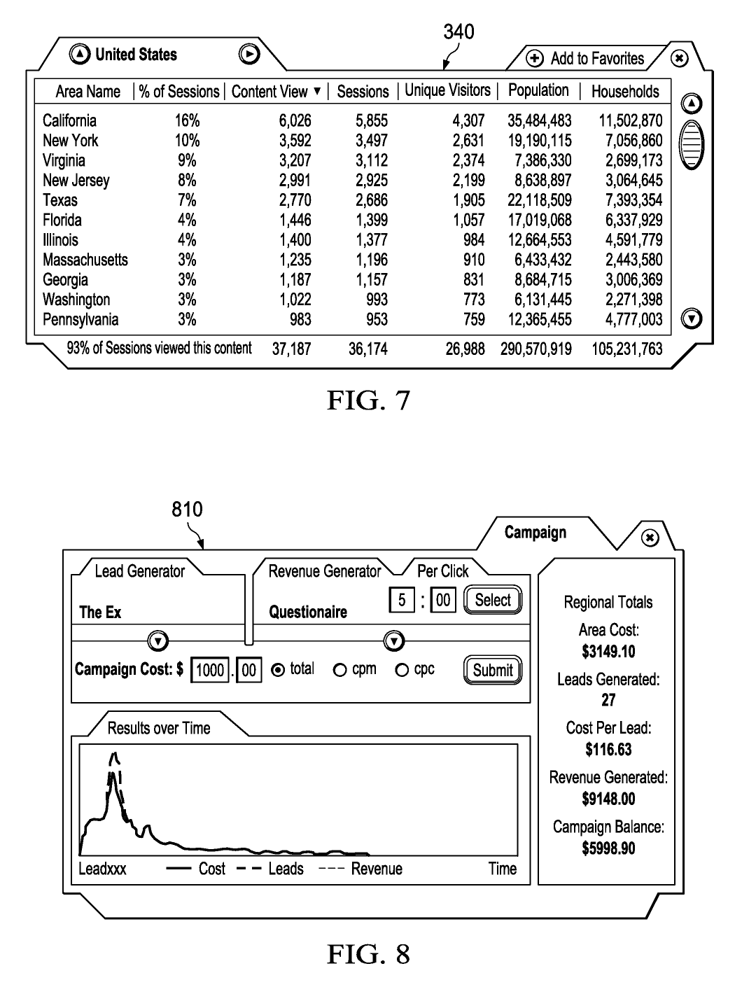

FIG. 7 is a more detailed screen capture of the map information panel 340. The map information panel 340 also allows the user select different ways of viewing a specific area, for example, when looking at Texas, the default view is to show the outlines of all of the MSAs in Texas. But the analyst can change this to view Texas by counties, or by Designated Marketing Areas (DMAs), which are used in the television and radio industry to denote coverage areas that determine advertising costs.

The map information panel 340 also works as a secondary navigation method. Meaning, if an analyst rolls over California in the map information panel 340, the response is the same as if the analyst had rolled over California on the map 300, and clicking on California in the map information panel 340 also brings up the map of California.

In one embodiment, the analyst can click a button on the map information panel 340 to add the current map 300 to their list of favorites, that show up in a favorites panel.

FIG. 8 is a screen capture of one embodiment of a campaign panel 810 as provided by one embodiment of a reporting server 130 constructed according to the principles of the invention. In general, the campaign panel 810 allows an analyst to specify pieces of their rich media content as lead generators, and specify revenue generators. An analyst can see how much money their campaigns are generating. The graph shows cost, leads and revenue over time.

More specifically, the campaign panel 810 allows an analyst specify a content element as a lead generator. Usually this action would be assigned to a form submission where user contact information was being collected. The campaign panel 810 also allows an analyst to specify how much their campaigns cost, either as a straight-up amount, or as CPM (cost per thousand impressions) or CPC (cost per click). This panel also allows an analyst to specify actions as revenue generators.

An analyst can assign a dollar value to content, or an action, and this panel will show an analyst how much money it cost to generate leads with this project, how much revenue the project generated, and the balance of the project (revenue−cost=balance) to let an analyst know how successful the projects are in terms of paying for themselves.

There is also a graph at the bottom of the campaign panel 810 that charts leads generated, revenue generated and costs generated overtime, so an analyst can see how changes they make have affected the success of a campaign over time.

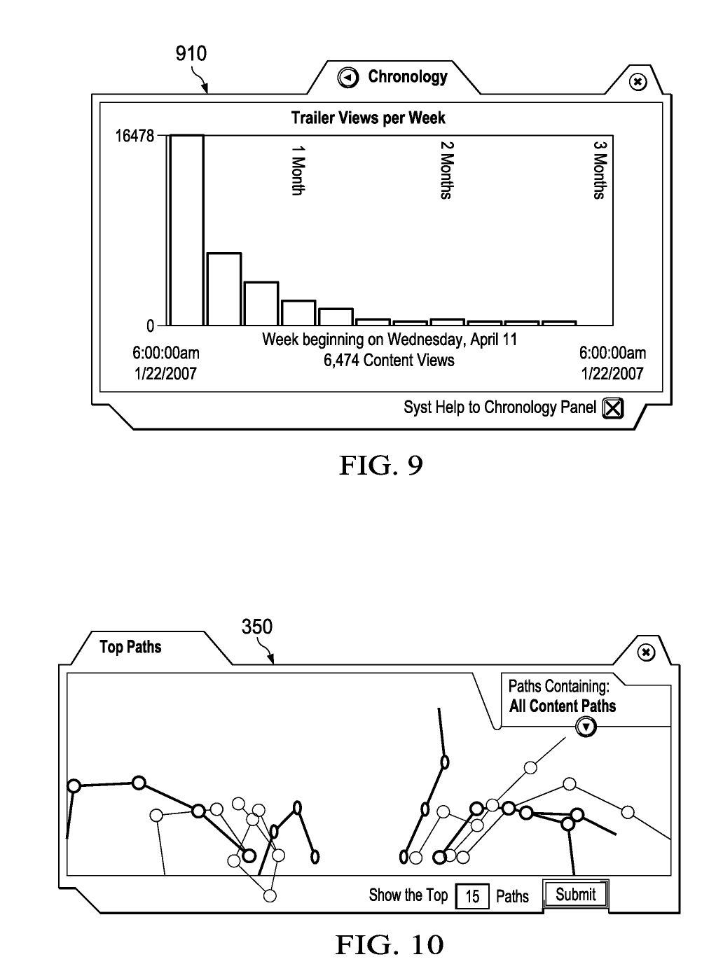

FIG. 9 is a screen capture of one embodiment of a chronology panel 910 as provided by one embodiment of a reporting server 130 constructed according to the principles of the invention. In general, the chronology panel 910 shows content views over time. The analyst may navigate through the data by clicking on large or small units of time as well.

More specifically, the chronology panel 910 details content views over time. When an analyst opens the chronology panel 910, it shows the number of views broken down in 30-day increments based on the start date that was set in the project panel 310. The information is displayed as a bar graph, and shows six 30-day periods.

There is a check box on the bottom of the chronology panel 910 labeled “Sync Map to Chronology Panel.” When this is selected, the start and end dates are affected, and a new query for the given map is run with the dates supplied by the chronology panel. Meaning, if an analyst is looking at a project that runs from 3/1 to 10/5, and he clicks on the first of the 30-day bars in the graph, the start and end dates for the map change to 3/1 and 3/31 respectively, and the query is re-run for the map 300. The chronology panel 910 is then updated to show a graph that shows the hits broken down by weeks over a 12-week period starting at 3/1.

Clicking on one of the week bars resets the chronology panel 910 to show the hits broken down by days, showing 30 days starting from the first day of the week bar that was hit, and updating the map 300 again if the “Sync Map to Chronology Panel” box is checked.

There is also a way to update the map 300 without updating the chronology panel 910. If the analyst holds the shift key down, the map 300 is automatically updated to show the time period that corresponds to the bar on which the analyst clicks in the chronology panel 910. This is a good way to see how the map 300 changes from day to day, if the daily view is selected.

Clicking on a day bar will break the views down into 24 hours, clicking an hour breaks it down into 60 minutes, and clicking on a minute will break the traffic down to a 60 second view. There is a “back” button at the top of the chronology panel 910 that allows an analyst to back up to the next higher time increment (minutes from seconds, months from weeks, etc.)

FIG. 10 is a screen capture of one embodiment of the top paths panel 350. In general, the top paths panel 350 shows clickstream data.

More specifically, the top paths panel 350 shows the top paths users used to navigate through the web content. There is a field that allows an analyst to specify the number of paths to be shown in the top paths panel 350, and a dropdown menu that allows an analyst to filter paths such that only show paths meeting filter requirements are shown. The paths look like weeds, and each segment represents a sub-element. When an analyst clicks on the background of the top paths panel 350, the path display stops spinning, when the analyst clicks on a specific path, the other paths fold down out of the way, and the selected path points straight up, and labels appear for each segment.

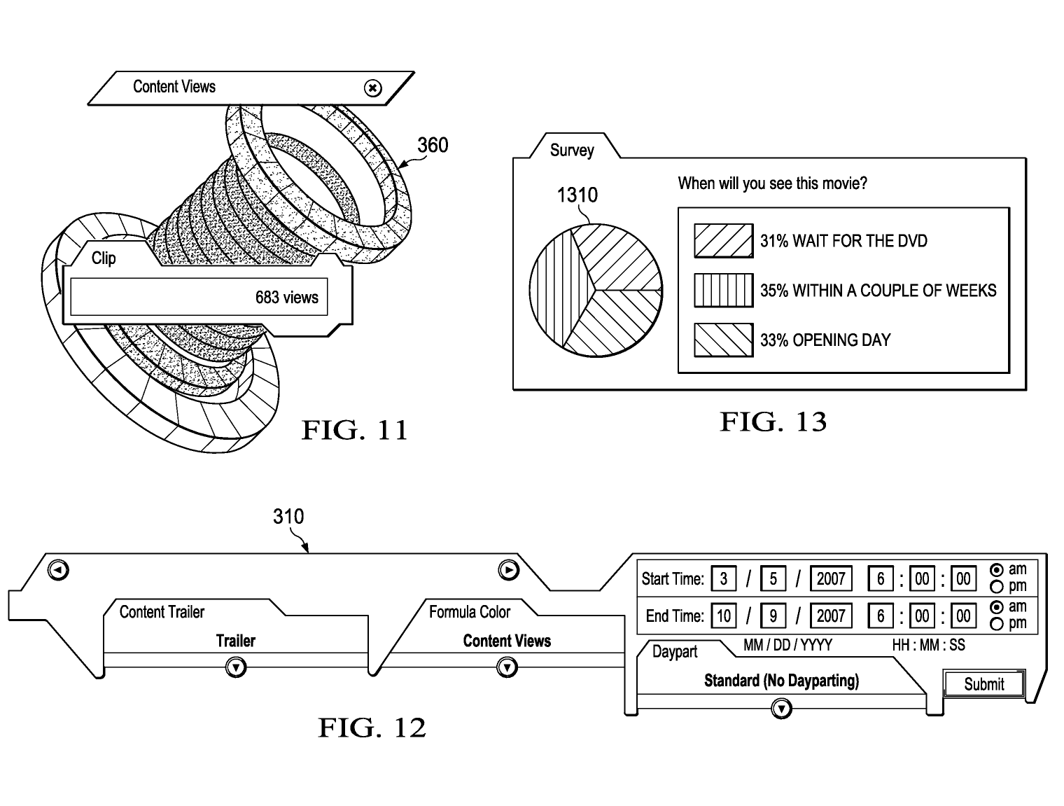

FIG. 11 is a screen capture of one embodiment of the content views panel 360. In general, the content views panel 360 shows the content views for all of the content clips spatially in the web content. More specifically, the content views panel 360 displays all of the sub-elements of a project as spinning rings. The rings get larger and are assigned a color closer to the highest legend color as they have more views, smaller and closer to the darkest legend color as they have fewer views. Rolling over the rings shows the name of the selected content, and the number of views it had. Clicking on a ring changes the map to show a report for the selected ring.

FIG. 12 is a screen capture of one embodiment of the project panel 310. In general, the project panel 310 allows an analyst to set the parameters for the map 300 by choosing the desired project and rich media content to be studied by using various demographic filters. All projects can be driven by date and time settings of individual preference or by accessing the traditional predefined “day parts” ranges used by broadcast. More specifically, the project panel 310 allows an analyst to select which project he wants to analyze, which sub-element of that project he want to reports on, what formula he wants to use to color the map 300, start and end times for the report, and what daypart he wants to report on. Day-parts are segments of time during a 24 hour period. For example, if an analyst runs a report from 10/1 to 10/30 with a primetime daypart (7 pm-10 pm), the information the analyst receives would be for hits that occurred between 7 pm and 10 pm on every weekday between the given date range (weekends being a separate daypart).

Formulas used to color the map are as simple as Content Views, or view by Population, to Content Views by percentage of Households in a given area. There are also formulas for coloring the map by Campaign dollars spent in a given area, leads generated in a given area, and revenue generated in a given area. We can basically build formulas for any demographic data in the database, recorded data from a project, or combination of both of the different information types.

FIG. 13 is a screen capture of one embodiment of a questionnaire panel 1310 as provided by one embodiment of a reporting server constructed according to the principles of the invention. In general, the questionnaire panel 1310 shows the answers that users gave to questions in a survey conducted online. The questionnaire panel 1310 updates the survey with appropriate information for each map 300 viewed.

More specifically, the questionnaire panel 1310 may be used to display answers users provided in response to surveys or questionnaires. The questionnaire panel 1310 shows the percentages and a pie chart with the answers supplied to each question. The percentages are updated based on the geographic region displayed on the map 300, so an analyst can identify differences in how different areas responded to the questions.

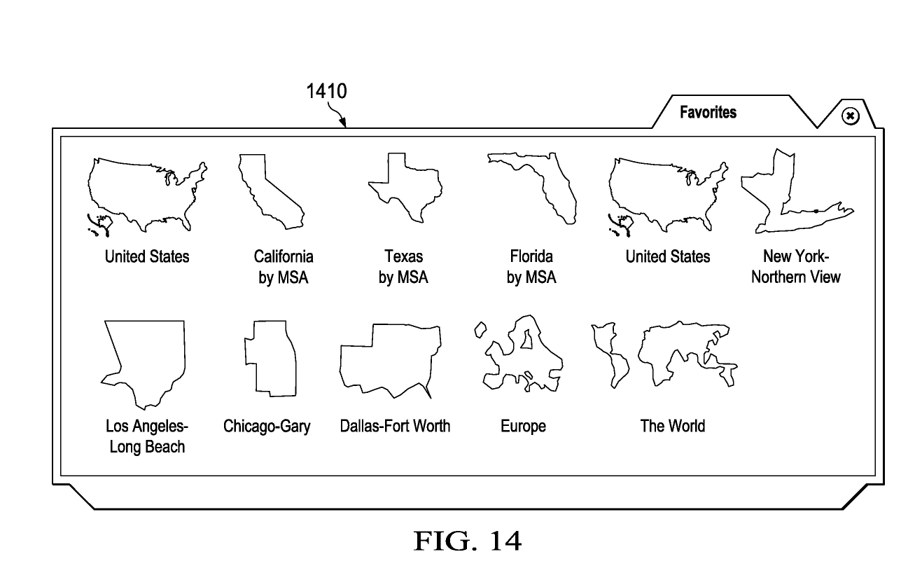

FIG. 14 is a screen capture of one embodiment of a favorites panel 1410 as provided by one embodiment of a reporting server constructed according to the principles of the invention. The favorites Panel 1410 has thumbnail versions of the maps that an analyst has specified as favorites. Clicking on a thumbnail navigates directly to that map, instead of going up map levels and going back down. So if the analyst has Chicago and New York City as favorites, he would not have to back up to the Illinois, US, New York State, then down to New York City. The analyst could instead jump straight from one to the other.

FIG. 15 is a screen capture of one embodiment of an organizations panel 1510 as provided by one embodiment of a reporting server constructed according to the principles of the invention. The organizations panel 1510 shows the top 20 organizations opened sessions in the mapped area, and the top 20 IP addresses within that organization. With the organizations panel 1510, an analyst can identify the major Internet portals in different markets, and possibly contact them for placing advertisements.

Having described the GUI image, one embodiment of a method of creating a message generator, associating the message generator with rich media and employing the message generator to generate messages carried out according to the principles of the invention will now be described. Different media formats are supported so that end an analyst can “tag” actions or content. All the format needs to be able to do is send and receive variables to the server-side scripts. The way this typically works is as follows. When the project file is initially downloaded, it sends a request for a script to the reporting server. The reporting server responds with a Session identifier number, and a list of content items, if the content is dynamic. Scripts are attached to interactive buttons or hyperlinks by the person assembling the content. Each action or link has a unique identifier assigned to it, and calls a script on the web client 120 that sends the session identifier, and the action identifier to the reporting server 130, which adds a time/date stamp to the activity.

In some cases, such as a web site, the scripts that record activity forward an analyst back to a Uniform Resource Locator (URL) either provided as a parameter, or pulled from the database. This is a direct method of reporting URLs that were clicked on a web site, which can be inconvenient for large or complex sites.

Otherwise, most rich media files allow more than one action to take place on an event, such as a button click, so the reporting action only sends the necessary information to the server, which replies with a “success” or “failure” message after it has attempted to enter the activity into the database, and this does not affect any of the other actions the designers want to occur on this button click.

Any software capable of requesting and receiving session identifier values over the Internet running on a game console, personal computer (PC), mobile device, etc. is a potential candidate for a custom application programming interface if necessary. Alternatively, it could be programmed to pass the required variables to existing scripts.

FIG. 16 is a flow diagram of one embodiment of a method of creating a message generator, associating the message generator with rich media and employing the message generator to generate messages carried out according to the principles of the invention. The method begins in a start step 1605, in which it is desired to create a message generator and associate it with rich media. In a step 1610, a rich media content creator creates a new project with the reporting server. In a step 1615, the reporting server generates a document class file that becomes a message generator for the new project.

The table below contains example source code for listener functions that may be in the document class file. The event listener calls them, and they call the message generator.

```
//Listener functions (Flash Actionscript 3)
    public static function
reporting_server_MOUSE_OVER(event:MouseEvent):void{
      reporting_server_track(‘Mouse Over’, event.currentTarget);
    }
    public static function
reporting_server_MOUSE_OUT(event:MouseEvent):void{
      reporting_server_track(‘Mouse Out’, event.currentTarget);
    }
    public static function
reporting_server_CLICK(event:MouseEvent):void{
      reporting_server_track(‘Click’, event.currentTarget);
    }
      public static function
reporting_server_DOUBLE_CLICK(event:MouseEvent):void{
      reporting_server_track(‘Double Click’, event.currentTarget);
    }
```

The table below contains example source code for a message generator. This is passed a string that describes the action taken and the target object. Typical examples would be reporting_server_track (“Click”, “Home Button”), or reporting_server_track (“Loaded”, “Movie Trailer”). The message generator takes these arguments, attaches the session identifier, project identifier, and a number that describes which “click number” it is, so the order in which the actions happened may be ascertained when top paths are later reported.

```
    //Message generator (Flash Actionscript 3)
    public static function reporting_server_track(actionType,
target) {
      var checkName:String = target.name.substring(0,8);
      var trackName:String;
      if(typeof target != “string’)
        {
          trackName = target.name+” (‘+actionType+’)’;
      } else {
      trackName = target+” (‘+actionType+’)’;
      }
        if(!actionType)
        {
      trace(‘WARNING - “+target+” will not be tracked because the track
function was not supplied an actionType argument (ex.: track(Rolled
Over);’);
      } else {
      if(checkName == “instance’)
          {
      trace(‘WARNING - “+target+” will not be tracked because the
instance on stage does not have an instance name assigned, please assign
a name through the properties panel’);
      } else {
      if(!session_path)
            {
      trace(‘WARNING - session_path variable not found’);
      } else {
      if(!session_so.data.sessionid){
      trace(‘Actions will not be tracked until a sessionID has been
received from the server, this should be near instantaneous.’);
      } else {
      var trackVars:URLRequest = new
URLRequest(session_path+’asp/record_session_action.aspx?
subMovieParentId=‘+ProjId+’&sessionID=
‘+String(session_so.data.sessionid)+
’&subName=‘+trackName+’&sequenceNum=‘+
String(session_so.data.sequencenum));
      //trace(‘loading
“+session_path+’asp/record_session_action.aspx?subMovieParentId=
‘+ProjId+‘&sessionID=‘+String(session_so.data.sessionid)+’&subName=
‘+trackName+‘&sequenceNum=‘+String(session_so.data.sequencenum));
      var trackLoader:URLLoader = new URLLoader( );
                  clickTarget = target;
      session_so.data.sequencenum =
Number(session_so.data.sequencenum)+1;
      trackLoader.addEventListener(Event.COMPLETE,
reporting_server_trackCompleteHandler);
      trackLoader.load(trackVars);
      }
      }
      }
      }
    }
```

The table below contains example source code for a specific function for tracking video through a video playback component. The function tracks what pieces of video, how many seconds of each piece of video and which seconds of each piece of video are being watched. The “which seconds” part is important because the number of times “second 22” was watched by all users can be counted, including determining whether users rewound to that point often.

```
    public static function video_track(videoName:String, cuePointArray:
Array, videoURL:String):void
    {
      var requestURL:String =
session_path+’asp/record_video_action.aspx?projectid=‘+ProjId+’
&sessionid=‘+String(session_so.data.sessionid)+’&videoname=
‘+videoName;for(var i:int=0; i<cuePointArray.length; i++)
{
      requestURL =
requestURL+’&second’+String(i)+’=‘+String(cuePointArray[i]);
}
requestURL = requestURL+’&videourl=‘+videoURL;
      var videoVars:URLRequest = new URLRequest(requestURL);
      var videoLoader:URLLoader = new URLLoader( );
videoLoader.addEventListener(Event.COMPLETE,
reporting_server_trackCompleteHandler);
videoLoader.load(videoVars);
    }
```

In a step 1620, the content creator adds the message generator to the project file. In a step 1625, the content creator adds an event listener that points to the message generator to a button or movie or file. The table below contains example source code for a listener.

//Event Listeners (Flash Actionscript 3)
myButton.addEventListener(MouseEvent.CLICK,
reporting_server_CLICK);

Having created a message generator and associated it with rich media, it is now desired to employ the message generator to generate messages. In a step 1630, the event listener detects an event. The table below contains example source code that checks to see if a flash cookie already on the web client. The code determines whether the user is already in an active session, or if he is a returning user.

```
if(session_so)
{
    if(session_so.data.expirydate)
    {
      trace(‘shared object has an expiry date of:
“+String(session_so.data.expirydate));
  if(session_so.data.expirydate.getTime( )<currentDate.getTime( ))
      {
  //They are a returning visitor, not in a current session
        trace(‘shared object has expired’);
        reporting_server_initSession( );
      }
        else
        {
```

The table below contains example source code that shows opening a session from flash, checking to see if the viewer is new, returning, or continuing a session from somewhere else. It also shows code for retrieving the user's geotargeted location back to the message generator for use within the web content, if desired. For example, the web content could cause a Cadillac banner that said “Find a dealer in Dallas” to be displayed if the geotargeted location indicates that the user is in Dallas.

```
  public class reporting_server extends MovieClip
  {
    // These variables are generated by the reporting_server when you
added your new project
    public static var ProjId:Number = 9;
    public var CompanyId:Number = 4;
    public static var session_path:String = “http://............................../’;
    public static var currentDate:Date = new Date( );
    public static var clickTarget:MovieClip;
    // These variables are specific to the client machine
    public var thePlayer:Object = setPlayer( );
    //tracking variables
    public static var sessionVars:XML;
    //ip & location variables
    public static var ipVars:XML;
    //Retrieve or set a new shared object for this project
    public static var session_so:SharedObject =
SharedObject.getLocal(‘reporting_serverTrackProj’+String(ProjId));
    //Retrieve the URL of the page the swf file is sitting on
    public var hostURL:String = setURL( );
      public function reporting_server( ):void
    (
```

The table below contains example source code for changing a session to expire in 15 minutes if a user is in an active session.

```
              session_so.data.expirydate = new
Date(currentDate.getTime( )+(1000*15*60));
              trace(‘shared object new expirydate:
“+String(session_so.data.expirydate));
              trace(‘shared object sessionID:
“+String(session_so.data.sessionid));
              trace(‘shared object has a sequencenum of:
“+String(session_so.data.sequencenum));
            }
          }
          else
          {
            reporting_server_initSession( );
          }
        }
        else
        {
// They don't have a cookie (likely a first time visitor)
          reporting_server_initSession( );
        }
```

In a step 1635, the message generator contacts the reporting server and generates a message corresponding to the event. In a step 1640, the message generator transmits the message to the reporting server. In a step 1645, the reporting server receives and stores the message in a database.

The table below contains example source code for a server-side script in which the location mapper records a new session in a messages/actions database.

```
//record_session_action.aspx.cs (C# asp codebehind)
  protected void Page_Load(object sender, EventArgs e)
  {
    string sessionID;
    string subName;
    string sequenceNum;
    string subMovieParentId;
    Response.Write(“<sessionaction>“);
    try
    {
      if (Request.RequestType == “POST”)
      {
        sessionID = Request.Form[“sessionID”];
        subName = Request.Form[“subName”];
        sequenceNum = Request.Form[“sequenceNum”];
        subMovieParentId = Request.Form[“subMovieParentId”];
      }
      else
      {
        sessionID = Request.QueryString[“sessionID”];
        subName = Request.QueryString[“subName”];
        sequenceNum = Request.QueryString[“sequenceNum”];
        subMovieParentId = Request.QueryString[“subMovieParentId”];
      }
    }
    catch (Exception exp)
    {
      Response.Write(“<status>failed</status>“);
      Response.Write(“<message>“ + exp + “</message>“);
      Response.Write(“</sessionaction>“);
      return;
    }
    try
    {
      this.SQLConnection1 = new
System.Data.SqlClient.SqlConnection( );
      this.SQLCommand1 =
      new System.Data.SqlClient.SqlCommand( );
      this.SQLConnection1.ConnectionString =
System.Configuration.ConfigurationManager.AppSettings[“sqlConn”];
      SQLConnection1.Open( );
      SQLCommand1.CommandType =
      CommandType.StoredProcedure;
      SQLCommand1.Parameters.Add(“@SessionID”,
SqlDbType.Int).Value =Convert.ToInt32(sessionID);
      SQLCommand1.Parameters.Add(“@ActionSequenceNum”,
SqlDbType.Int).Value = Convert.ToInt32(sequenceNum);
      SQLCommand1.Parameters.Add(“@SubMovieParentId”,
SqlDbType.Int).Value = Convert.ToInt32(subMovieParentId);
      SQLCommand1.Parameters.Add(“@SubMovieName”,
SqlDbType.VarChar).Value = subName;
      SQLCommand1.Connection = SQLConnection1;
      SQLCommand1.CommandText = “dsp_flash_session_action”;
      SqlDataReader dr =
SQLCommand1.ExecuteReader(CommandBehavior.Default);
```

The table below contains example source code for a server-side script in which the location mapper records action pertaining to a session in a messages/actions database.

```
//dsp_flash_session_action (SQL stored procedure)
CREATE PROCEDURE [dbo].[dsp_flash_session_action]
@SessionID int,
@ActionSequenceNum int,
@SubMovieParentId int,
@SubMovieName nvarchar(50)
AS
DECLARE @SubID int
DECLARE @status char(7)
DECLARE @error varchar(128)
BEGIN
-- SET NOCOUNT ON added to prevent extra result sets from
-- interfering with SELECT statements.
SET NOCOUNT ON;
SET @status = NULL
SET @error = NULL
IF (SELECT count(*) from Movies where MovieID =
@SubMovieParentID) = 0
BEGIN
  set @status = “Failure’
  if @error IS NULL set @error = “Bad MovieID Parameter’
END
IF @error IS NULL
BEGIN
    set @SubID = NULL
SELECT @SubID = SubMovieID FROM SubMovies where
SubMovieName = @SubMovieName
    IF @SubID IS NULL
BEGIN
INSERT INTO
[dbo].[SubMovies]([SubMovieParentID],[SubMovieIndex],
  [SubMovieRegion],[SubMovieSuperRegion],[SubMovieCountry],
  [SubMovieURL],[SubMovieName],[SubMovieDuration],
  [SubMovieStatus],[SubMovieLead],[SubMovieRevenue])
VALUES
(@SubMovieParentId,0,NULL,NULL,NULL,@SubMovieName,
@SubMovieName,NULL,0,0,0)
set @SubID = scope_identity( )
END
-- generate actionsequencenum, ignore parameter
    set @ActionSequenceNum = NULL
    select @ActionSequenceNum = Max(ActionSequenceNum) from
dbo.SessionActions
            where sessionid = @Sessionid
    IF @ActionSequenceNum IS NULL
      SET @ActionSequenceNum = 1
    ELSE
      SET @ActionSequenceNum = @ActionSequenceNum + 1
INSERT INTO
[dbo].[SessionActions]([SessionID],[ClickedIndex],[ActionDateTime],
  [ActionSequenceNum],[SubID],[ActionDuration])
VALUES (@SessionID,0,getdate( ),@ActionSequenceNum,
@SubID,NULL)
SELECT “Success’,NULL
END
ELSE
SELECT @status,@error
END -- end of proc
GO
```

In a step 1650, the reporting server notifies the message generator of the success or failure of the transmission. The table below contains example source code for a server-side script in which the location mapper sends a message back to the message generator acknowledging that either tracking has completed successfully or not.

```
        if (dr.Read( ))
      {
        string status = dr[0].ToString( );
        Response.Write(“<status>“ + status + “</status>“);
      }
      //Clean up objects and close database
      dr.Close( );
      dr.Dispose( );
      SQLConnection1.Close( );
      SQLConnection1.Dispose( );
    }
    catch (Exception exp)
    {
  // ... or it failed
      Response.Write(“<status>failed</status>“);
      Response.Write(“<message>“ + exp + “</message>“);
    }
    Response.Write(“</sessionaction>“);
  }
}
```

The table below contains example source code for a function call that not only starts a new session, but also that prompts the location mapper to return the user's IP address and geographical location information back if the rich media content needs it (“Find a Dealership in Dallas!”) for users in Dallas.

```
reporting_server_get_location( );
        }
        //This is the function that sends the information to the server
        //to start a new session
        public function reporting_server_initSession( ):void
        {
            var request:URLRequest;
    // The string sent to the server also sends information about
    // the player version, os, and the url that is displayed in the
    // person's browser when they see the file.
    // This last part is important for tracking which sites are
    // displaying your message generator (banner ad)
            if(!session_so.data.guid)
            {
          request = new URLRequest(session_path+’asp/
record_session.aspx?guid=null&sessionMovieID=‘+ProjId+’
&version=‘+thePlayer.version+’&os=‘+thePlayer.platform+’
&companyID=‘+CompanyId+’&hostURL=‘+hostURL);
          } else {
// otherwise send the guid
          request = new
URLRequest(session_path+’asp/record_session.aspx?guid=‘+
session_so.data.guid.toString( )+’&sessionMovieID=‘+ProjId+
‘&version=‘+thePlayer.version+’&os=‘+thePlayer.platform+’
&companyID=‘+CompanyId+’&hostURL=‘+hostURL);
}
//trace (String(request.url));
          var loader:URLLoader = new URLLoader( );
loader.addEventListener(Event.COMPLETE,
reporting_server_sessionCompleteHandler);
loader.load(request);
          }
```

The table below contains example source code for a server-side script in which the location mapper acknowledges a successful track and the session timer gets reset to another 15 minutes out. Also, if the reporting server is unreachable for some reason, the rich media continues to function.

```
//Tracking Complete (Flash Actionscript 3)
    public static function
reporting_server_trackCompleteHandler(event:Event):void
    {
      var trackResults:XML = XML(event.target.data);
      if(trackResults.status == “Success’){
    trace(‘successfully tracked’);
        currentDate = new Date( );
        session_so.data.expirydate = new
Date(currentDate.getTime( )+(1000*60*15));
      } else {
      trace(‘Error: “+trackResults.error);
      }
      //whether there is a tracking error or not, navigate to URL if
there is one present
      if(clickTarget.urlString)
      {
        var urlReq:URLRequest = new URLRequest( );
        urlReq.url = clickTarget.urlString;
        if(clickTarget.targetWindow)
        {
          navigateToURL(urlReq, clickTarget.targetWindow);
        }
        else
        {
          navigateToURL(urlReq, “_self’);
        }
      }
    }
```

The method ends in an end step 1655.

FIG. 17 is a flow diagram of one embodiment of a method of performing rich media content web site analytics carried out according to the principles of the invention. The method begins in a start step 1710. In a step 1720, messages are received from rich media message generators over a network. In a step 1730, log entries are also received over the network. As previously described, the log entries are associated with web content expressed in a markup language and including rich media content in which the rich media message generators are included. In a step 1740, geographical locations are associated with the messages based on logical addresses contained therein. In a step 1750, associations are created among the messages based on aggregation criteria received from a reporting client. In a step 1760, at least one representation is generated based on the associations. In a step 1770, the at least one representation is transmitted to the reporting client. The method ends in an end step 1780.

Certain embodiments of the invention further relate to computer storage products with a computer-readable medium that have program code thereon for performing various computer-implemented operations that embody the tools or carry out the steps of the methods set forth herein. The media and program code may be those specially designed and constructed for the purposes of the invention, or they may be of the kind well known and available to those having skill in the computer software arts. Examples of computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Those skilled in the art to which the invention relates will appreciate that other and further additions, deletions, substitutions and modifications may be made to the described embodiments without departing from the scope of the invention.

What is claimed is:

1. A reporting server, comprising:
a location mapper configured to receive messages directly from rich media message generators over a network and associate geographical locations with said messages based on logical addresses contained therein;
an analytics engine coupled to said location mapper and configured to create associations among said messages based on aggregation criteria received from a reporting client; and
a graphical user interface generator coupled to said analytics engine and configured to generate at least one representation based on said associations and transmit said at least one representation to said reporting client.

2. The reporting server as recited in claim 1 wherein said location mapper is further configured to receive log entries over said network, said log entries associated with web content expressed in a markup language and including rich media content in which said rich media message generators are included.

3. The reporting server as recited in claim 1 wherein said rich media message generators are embodied in a sequence of executable computer instructions expressed in a computer language selected from the group consisting of:
Flash®,
QuickTime®, and
Silverlight®.

4. The reporting server as recited in claim 1 wherein said logical addresses are Internet Protocol addresses.

5. The reporting server as recited in claim 1 wherein said aggregation criteria are received from said reporting client over said network and said at least one representation is transmitted to said reporting client over said network.

6. The reporting server as recited in claim 1 wherein said representations are selected from the group consisting of:
an engagement panel,
a map information panel,
a campaign panel,
a chronology panel,
a top paths panel,
a content views panel,
a project panel,
a questionnaire panel,
a favorites panel, and
an organizations panel.

7. The reporting server as recited in claim 1 wherein said analytics engine is further configured to associate actions with said messages based on identifiers contained therein.

8. The reporting server as recited in claim 1 wherein said rich media message generators are associated with rich media content originating at a source other than a web site.

9. A method of performing rich media content web site analytics, comprising:
receiving messages directly from rich media message generators over a network;
associating geographical locations with said messages based on logical addresses contained therein;
creating associations among said messages based on aggregation criteria received from a reporting client;
generating at least one representation based on said associations; and
transmitting said at least one representation to said reporting client.

10. The method as recited in claim 9 further comprising receiving log entries over said network, said log entries associated with web content expressed in a markup language and including rich media content in which said rich media message generators are included.

11. The method as recited in claim 9 wherein said rich media message generators are embodied in a sequence of executable computer instructions expressed in a computer language selected from the group consisting of:
Flash®,
QuickTime®, and
Silverlight®.

12. The method as recited in claim 9 wherein said logical addresses are Internet Protocol addresses.

13. The method as recited in claim 9 wherein said aggregation criteria are received from said reporting client over said network and said transmitting comprises transmitting said at least one representation to said reporting client over said network.

14. The method as recited in claim 9 wherein said representations are selected from the group consisting of:
an engagement panel,
a map information panel,
a campaign panel,
a chronology panel,
a top paths panel,
a content views panel,
a project panel,
a questionnaire panel,
a favorites panel, and
an organizations panel.

15. The method as recited in claim 9 further comprising associating actions with said messages based on identifiers contained therein.

16. The method as recited in claim 9 wherein said rich media message generators are associated with rich media content originating at a source other than a web site.

17. A network analytics infrastructure, comprising:
web content locatable at web servers, transmittable to web clients over the Internet and including rich media content and associated rich media message generators; and
a reporting server, comprising:
a location mapper configured to receive, over the Internet, messages from said rich media message generators transmitted to said web clients and associate geographical locations with said messages based on Internet Protocol addresses contained therein,
an analytics engine coupled to said location mapper and configured to create associations among said messages based on aggregation criteria received from a reporting client, and
a graphical user interface generator coupled to said analytics engine and configured to generate at least one representation based on said associations and transmit said at least one representation to said reporting client.

18. The infrastructure as recited in claim 17 wherein said location mapper is further configured to receive log entries from said web servers over the Internet, said log entries associated with said web content.

19. The infrastructure as recited in claim 17 wherein said rich media message generators are embodied in a sequence of executable computer instructions expressed in a computer language selected from the group consisting of:
Flash®,
QuickTime®, and
Silverlight®.

20. The infrastructure as recited in claim 17 wherein said aggregation criteria are received from said reporting client over the Internet and said at least one representation is transmitted to said reporting client over the Internet.

21. The infrastructure as recited in claim 17 wherein said representations are selected from the group consisting of:
an engagement panel,
a map information panel,
a campaign panel,
a chronology panel,
a top paths panel,
a content views panel,
a project panel,
a questionnaire panel,
a favorites panel, and
an organizations panel.

22. The infrastructure as recited in claim 17 wherein said analytics engine is further configured to associate actions with said messages based on identifiers contained therein.

23. The infrastructure as recited in claim 17 wherein said rich media message generators are further associated with rich media content originating at a source other than a web site.

24. A rich media message generator embodied in a sequence of executable computer instructions expressed in a computer language selected from the group consisting of:
Flash®,
QuickTime®, and
Silverlight®,
and configured to be associated with rich media, transmitted to a web client over the Internet, generate rich media messages and cause said rich media messages to be transmitted to a reporting server over the Internet.
